(19) United States
(12) Patent Application Publication
(10) Pub. No.: US 2005/0240297 A1
(43) Pub. Date: Oct. 27, 2005

(54) System and method of providing music items to music renderers

(76) Inventors: Shawn Scotzin, Redmond, WA (US); Alan Q. Li, Kirkland, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/159,885

(22) Filed: Jun. 23, 2005

Related U.S. Application Data
(62) Division of application No. 09/550,545, filed on Apr. 14, 2000.

(51) Int. Cl. G06F 17/00; G10H 7/00

(52) U.S. Cl. 700/94

(57) ABSTRACT

A system of providing music items to music renderers. One embodiment of the system comprises an electronic music player that is connected to a plurality of music renderers via device drivers via a music renderer controller. The music renderer controller comprises a device integration application program interface for providing a standard interface for communicating with each of the device drivers. Each of the device drivers manage a selected music renderer. The device drivers receive the music items that are in a predefined format a store the music items on the music renderers upon requests from the electronic music player.

### RELATED APPLICATION

This application is a divisional application of and claims priority benefit under 35 U.S.C. §120 from U.S. application Ser. No. 09/550,545, filed Apr. 14, 2000, the disclosure of which is hereby incorporated by reference in its entirety herein.

### BACKGROUND OF THE INVENTION

1. Field of the Invention

The field of the invention relates to music renderers. More particularly, the field of the invention relates to providing music items to music renderers.

2. Description of the Related Technology

With the advent of new music storage formats, such as MPEG, Audio Layer 3 (MP3), the music industry has seen a remarked increase with respect to individuals using their home computer for playing music and with respect to individuals purchasing new types of music renderers, such as portable music devices, for playing music.

Using these new music storage formats, it is possible to shrink the sound data from sources such as a compact diskette (CD) without sacrificing sound quality. CDs typically render music at about 1400 kilobits per one second of stereo music. However, by converting data from a CD to another data format, such as MP3, the size of the data can be shrunk by a factor of about 12 without significantly sacrificing the quality of the music.

Many individuals use the Internet to find and download music to their personal computer. At the personal computer, the user can, via a playback device program, play, edit, or copy the downloaded music. Furthermore, from the personal computer, the user can download the music to a portable music player so that the downloaded music can be played wherever the user travels. Portable music players, such as the Diamond Rio 500, allow individuals store up to two hours of digital-quality music and up to 32 hours of spoken audio programs. The Diamond Rio includes 64 MB onboard memory, expandable to 96 MB with removable flash cards.

However, one problem that has been encountered by some users is that upon the purchase of a new music renderer to replace an old music renderer, the new music renderer may not support the format of music as it is stored on the user's computer. Before a user can copy music from the computer to a new music renderer, the user needs to determine which formats are supported by the new music renderer and to acquire a conversion utility to modify the music from the first format to the second format. If the user still uses the old music renderer, the user would need to maintain a copy of the music in the old format.

Another problem that has been encountered by manufacturers of new music renderers is that it is difficult to communicate with legacy playback device programs that are on an individual's personal computer. The playback device program of the individual's personal computer is typically statically designed to operate with a selected music renderer, e.g., the Diamond Rio. Thus, to enable the user to copy music between the individual's computer and a new music renderer, e.g., RCA's Lyra, the manufacture needs to provide a new playback device program in support of the new music renderer. Disadvantageously for the individual, the individual needs to maintain multiple playback devices for each of the individual's music renders.

Accordingly, there is a need for a system that allows individuals to easily copy and move music between personal computers and music renderers. The system should allow individuals to easily integrate new music renderers with the individual's playback device program. When copying from a selected source, such as the personal computer, to a destination, such as one of the music renderers, the system should automatically transform the music from its form at the source to a format which is required by the destination.

### SUMMARY OF THE INVENTION

One embodiment of the invention comprises a music rendering system, comprising a music controller for managing at least one music item, the music controller providing a pre-defined interface for connecting a device driver to the music controller during the operation of the music controller, and at least one device driver that is in communication with the music controller via a pre-defined interface, the device driver receiving and transmitting the music item to a music renderer.

Another embodiment of the invention comprises a music management system, comprising a plurality of music items, an output device, and a hierarchical graphical library tree that is displayed on the output device, the hierarchical graphical library tree graphically classifying the music items into one or more sets, the hierarchical graphical library tree having a plurality of nodes, each of the nodes being represented by either a graphical image or text, one or more of the nodes being movable or copyable from a first location in the hierarchical graphical library tree to a second location in the hierarchical graphical library tree.

Yet another embodiment of the invention comprises a method of manufacturing a system for integrating one or more music renders with an electronic music player, comprising providing an electronic music player, and providing a music renderer controller that has a plurality of pre-defined interfaces for communicating with the music renderers, the pre-defined interfaces including an interface for writing a music item to the music renderers and for retrieving attribute information about the music renderers, the pre-defined interfaces adapted to be dynamically linked with a device driver that is associated with a selected one of the music renderers.

Yet another embodiment of the invention comprises a method of transmitting a music item from a computer to a music renderer, the method comprising: executing an application program that provides a device integration application programming interface, dynamically linking a device driver to the application program via the device integration application interface, and requesting, via the device integration application interface, the device driver to store a selected music item on the music renderer.

Yet another embodiment of the invention comprises a system for transmitting a music item from a computer to a music renderer, the system comprising means for executing an application program that provides a device integration application programming interface, means for dynamically linking a device driver to the application program via the device integration application interface, and means for requesting, via the device integration application interface, the device driver to store a selected music item on the music renderer.

### BRIEF DESCRIPTION OF THE DRAWINGS

FIG. 1 is a high level block diagram illustrating one embodiment of a network configuration that may be used in connection with a music system, the music system comprising a server computer, a client computer, a music player, a music renderer controller, a plurality of music renderers, and a plurality of the device drivers that are associated respectively with selected ones of the music renderers.

FIG. 2 is block diagram illustrating the relationship between the music renderers of FIG. 1 and a plurality of storage devices that are associated with the music renders.

FIG. 3 is a block diagram illustrating a plurality of interfaces between the music controller of FIG. 1 and each of the device drivers of FIG. 1.

FIG. 4 is an exemplary screen display illustrating a control panel for organizing the music items that are maintained by the client computer of FIG. 1.

FIG. 5 is a flowchart illustrating a process of utilizing the music player of FIG. 1.

### DETAILED DESCRIPTION OF EMBODIMENTS OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

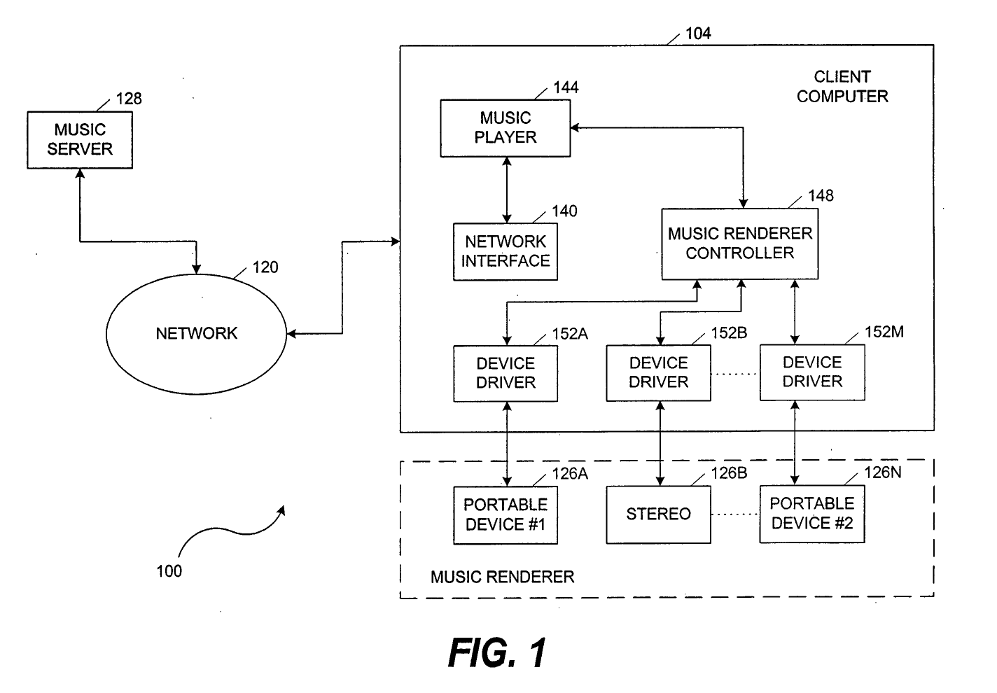

Referring to FIG. 1, an exemplary network configuration 100 of the music system of the present invention will be described. A user communicates with a computing environment which may include a client computer 104, a network 120, music renderers 126A-126N, and a music server 128. The client computer 104 and each of the music renderers 126A-126N has an associated input and output device. For example, the input device may be a keyboard, rollerball, pen and stylus, mouse, voice recognition system, or predesignated switches or buttons. The input device may also be a touch screen associated with an output device. The user may respond to prompts on the display by touching the touch screen. Textual or graphic information may be entered by the user through the input device. The output device can comprise a speaker, a display screen, a printer, or a voice synthesizer.

The client computer 104, the music server 128, and the music renderers 126A-126N may each have any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor. Furthermore, the client computer 104, the music server 128, and each of the music renderers 126A-126N may each be used in connection with various operating systems such as: UNIX, LINUX, Disk Operating System (DOS), VxWorks, PalmOS, OS/2, Windows CE, Windows 3.X, Windows 95, Windows 98, and Windows NT.

The music renderers 126A-126N can comprise a stationary device, such as a stereo system, or, alternatively, a portable device, such as a Diamond RIO, a RCA Lyra, a portable radio, or a personal display adapter.

Still referring to FIG. 1, the client computer 104 comprises a network interface 140, an electronic music player 144, a music renderer controller 148, and device drivers 152A-152M. The network interface 140 communicates with a control program of the music server 128 via the network 120. As is discussed in further detail below, using the music player 144, a user can communicate with the music server 128 to download and play songs via the output device of the client computer 104. Furthermore, using the electronic music player 144, a user can organize the songs according to subject matter and also download the songs to one of the music renderers 126A-126N.

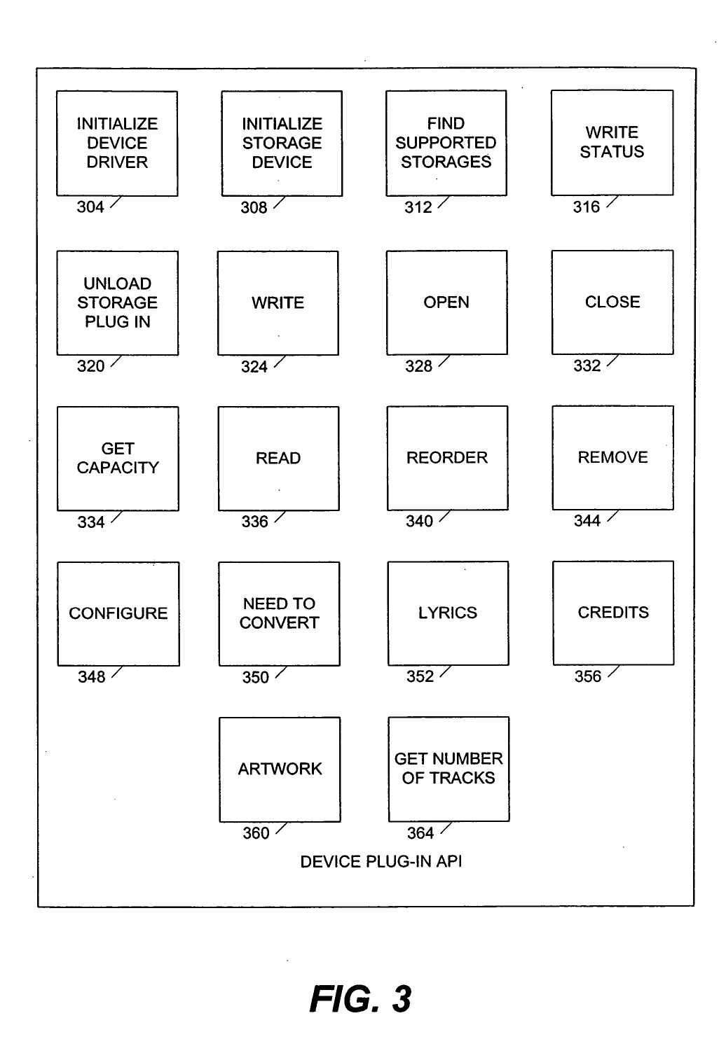

The music renderer controller 148 controls communications between the music player 144 and the music renderers 126A-126N. The music renderer controller 148 comprises a device integration application program interface (DIAPI) that provides a predefined interface for communicating with the device drivers 152A-15M. Using the DIAPI, programmers can develop new device drivers 152A-152M for integration within the client computer 104. In one embodiment of the invention, the DIAPI is based upon the Component Object Model (COM), which was developed by Microsoft Inc. of Redmond Wash. The DIAPI is described in further detail below with reference to FIG. 3.

In one embodiment of the network configuration 100, the client computer 104 includes a network browser that is used to access the music server 128. In another embodiment of the invention, the music renderers 126A-126N includes a network browser and can connect directly to the network 120. A user that is accessing the client computer 104 may utilize the network browser to remotely access a control program that is executing at the music server 128. The user can electronically request, via the network browser, the music server 128 to transmit selected music items from the music server 128 to the client computer 104. The music items can either be a music track, a folder comprising multiple music tracks, or some other logical grouping of musical sounds. The electronic request from the client computer 104 (FIG. 1) can correspond to one of any number of network protocols. In one embodiment of the invention, the electronic request comprises a Hypertext Transfer Protocol (HTTP) request. However, it is to be appreciated that other types of network communication protocols may be used.

It is noted that although only one client computer 104 and three music renderers 126A-126N are shown in FIG. 1, the network configuration 100 can include large numbers of such devices, e.g., millions. It is also noted that only one music server 128 is shown, the network configuration 100 can include a large number of such servers. Furthermore, the music server 128 can include a number of computers that work collaboratively to provide music in response to requests from the client computer 104.

The network 120 may include any type of electronically connected group of computers including, for instance, the following networks: a virtual private network, a public Internet, a private Internet, a secure Internet, a private network, a public network, a value-added network, an intranet, and the like. In addition, the connectivity to the network may be, for example, remote modem, Ethernet (IEEE 802.3), Token Ring (EEE 802.5), Fiber Distributed Datalink Interface (FDDI) or Asynchronous Transfer Mode (ATM). The network 120 may connect to the client computer 104, for example, by use of a modem or by use of a network interface card that resides in the client computer 104.

As can be appreciated by one of ordinary skill in the art, the control program of the music server 128, the network interface 140, the music player 144, the music renderer controller 148, and the device drivers 152A-152M may each comprise various sub-routines, procedures, definitional statements, and macros. Each of the foregoing modules are typically separately compiled and linked into a single executable program, e.g., the music player 144. However, it is to be appreciated by one of ordinary skill in the art that the processes that are performed by selected ones of the modules may be arbitrarily redistributed to one of the other modules, combined together in a single module, made available in a shareable dynamic link library, or partitioned in any other logical way. For example, in one embodiment of the invention, the music player 144 and the music renderer controller 148 are integrated into a single executable module. Furthermore, for example, in another embodiment, the device drivers 152A-125N are maintained in a dynamic link library that is separate from the music player 144 and the music renderer controller 148.

Furthermore, the control program of the music server 128, the network interface 140, the music player 144, the music renderer controller 148, and the device drivers 152A-152M may be written in any programming language such as C, C++, BASIC, Pascal, Java, and FORTRAN and ran under the well-known operating system. C, C++, BASIC, Pascal, Java, and FORTRAN are industry standard programming languages for which many commercial compilers can be used to create executable code. Furthermore, the control program of the music server 128, the network interface 140, the music player 144, the music renderer controller 148, and the device drivers 152A-152M can be either an “application program”, reside as part of the operating system for the device, or can reside partly in both.

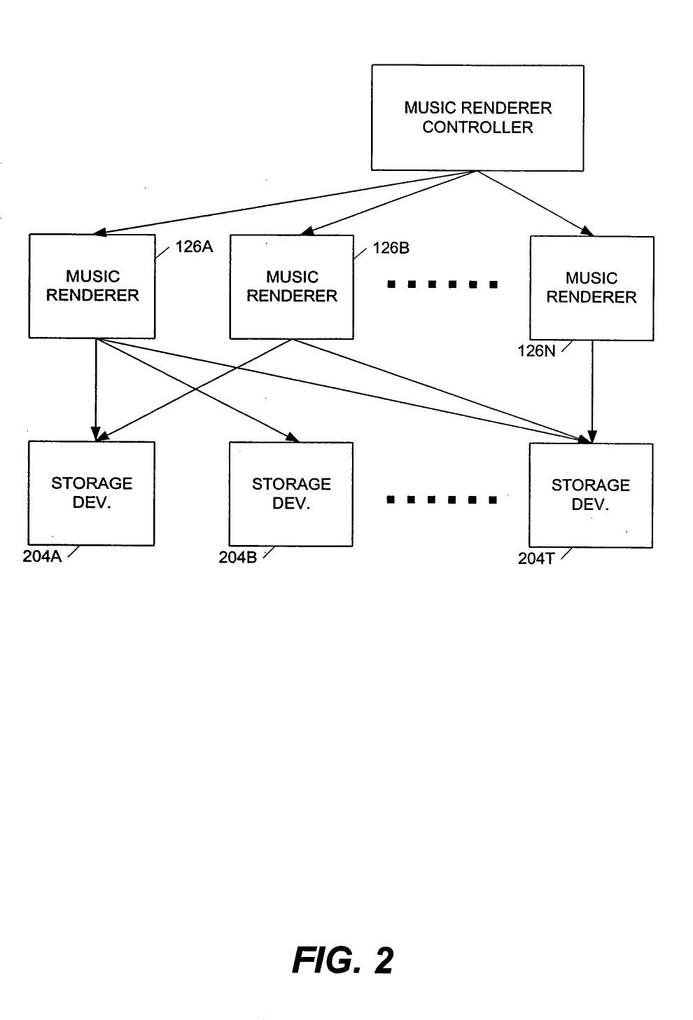

FIG. 2 is a block diagram illustrating the relationship between the music renderers 126A-126N and a plurality of storage devices 204A-204T. The storage devices 204A-204T may be integrated with one or more of the media renderers 126A-126N or alternatively, connected directly or indirectly to the client computer 104. For example, the storage devices 204A-204T can comprise non-volatile random access memory, flash memory, or a mass storage, such as is found in a hard drive.

In one embodiment of the invention, each of the storage devices 204A-204T is associated with a device object, e.g., one of the device drivers 152A-152M. Furthermore, in this embodiment, each of the storage devices 204A-204T is associated with a storage object. The device object defines an interface for transmitting music items to the music renderer. The storage object defines an interface for performing storage functions on the associated storage device.

FIG. 3 is a block diagram illustrating the various API's of the device drivers 152A-152M. Using the API's, the music renderer controller 148 can communicate with the device drivers 152A-152N. Since the API's are predefined and may be made publicly available, a device manufacturer can develop music renderers and device drivers for integration and connection to the music renderer controller 148 and the music player 144.

As is shown in FIG. 3, each of the device drivers 152A-152M provide the following interfaces: an initialize device driver interface 304, an initialize storage device interface 308, a find supported storage interface 312, a write status interface 316, an unload storage interface 320, a write interface 324, an open interface 328, a close interface 332, a get capacity interface 334, a read interface 336, a write done interface 340, a remove interface 344, a configure interface 348, a need-to-convert interface 350, a lyrics interface 352, a credits interface 356, an artwork interface 360, and a get number of tracks interface 364. Each of the foregoing interfaces are entry points into the device drivers 152A-152M. By invoking or “calling” one of the entry points, the music renderer controller 148 can request a respective device driver to perform a predefined function. It is noted that depending on the embodiment, the device drivers 152A-152M may have additional or fewer interfaces than are illustrated in FIG. 3.

Invoking the initialize device driver interface 304 causes the invoked device driver to create an “instance” of a music renderer data object that is used to represent one of the music renderers 126A-126N. In one embodiment, the initialize storage device interface 308 is invoked by the music renderer controller 148 prior to invoking the other interfaces of the music renderer. During initialization, the invoked device driver can download any components that may be missing from the client computer 104 that are needed for operation. Invoking the initialize storage interface 308 causes the invoked device driver to initialize one of the storage devices 204A-204T.

In one embodiment of the invention, the name of one of the music renderers 126A-126N and a graphical icon is provided to in response an invocation of the initialize device driver interface 304. For example, upon initializing the device driver, the device driver can inform a requestor that the name of the device that is managed by the device driver is “Diamond Rio.” In another embodiment of the invention, the DIAPI comprises separate interfaces for requesting the name of a selected music renderer and any graphical icons that may be associated with the music renderer.

Invoking the find supported storage interface 312 causes the invoked device driver to identify which of storage devices 204A-204T are associated with a respective one of the music renderers 126A-126N.

Invoking the write status interface 316 causes the invoked device driver to provide the status of a requested write operation to one of the storage devices 204A-204T. The unload storage adapter interface 320 provides an interface for removing one of the device drivers from the music player 144. Upon being invoked, the unload storage adapter interface 320 can perform actions such as deleting files, releasing memory, removing entries from registries, etc.

Invoking the write file interface 324 causes the invoked adapter driver to write a music item that was provided as part of the invocation to one of the storage devices 204A-204T.

The open interface 328 “opens” a particular music item from a specified one of the storage devices 204A-204T. The close interface 332 “closes” a music item from a specified one of the storage devices 204A-204T. It is noted that as with respect to each of the interfaces in the DIAPI, each provider of the device drivers and the music renderer can decide which actions are performed upon invocation of the respective interfaces. Accordingly, some interfaces such as open and close may not be necessary for selected music renderers.

By calling the read interface 336, the music renderer controller 148 can read a specified music item from a specified one of the storage devices 204A-204T and provide the specified music item to the music player 144.

The get capacity interface 334 may be called to obtain updated track information with respect to a storage device. In one embodiment of the invention, in response to a call to the get capacity interface 334, the called device driver returns the total number of track bytes that are used by the music renderer, the total number of free bytes that are free with respect to the music renderer, and the total number of bytes that are associated with the music renderer.

Still referring to FIG. 3, the reorder interface 340 reorders selected music items on a specified one of the storage devices 204A-204T. Invoking the remove storage interface 344 causes the adapter driver to remove a selected music item from one of the storage devices 204A-204T.

Invoking the configure interface 348 allows a user to configure or select one or more options that are available with respect to the music renderer that is managed by the invoked device driver. In one embodiment of the invention, invoking the configure interface 348 causes the respective device driver to display a configuration menu to the user of the client computer 104. Depending on the desires of the manufacturer of the device driver, the device driver can allow the user to select one of various options with respect to the music renderer that is managed by the device driver. For example, the user can define: (i) a bit rate for the respective music renderer; (ii) whether graphical icons should be stored on the graphical interface for the music renderer; (iii) a font type that is to be used with the music renders; (iv) or any other characteristic of the music renderer. For example, if a music renderer only supports selected bit-rates, the device driver can inform the music player 144 to transcode and transcrypt a track from one bit-rate to one of the supported bit-rates.

Invoking the need-to-convert interface 350 provides information as to whether the music should be formatted by the music player 144 prior to transmitting a selected music item to the device driver. In one embodiment, the need-to-convert interface 350 returns a Boolean value indicating whether the music player 144 should convert a selected music item before transmitting the music item to the device driver.

The lyrics interface 352 allows the music renderer controller 148 to read lyrics that are associated with a selected music item, or to alternatively, to associate and store lyrics with a selected music item on the music renderer. In one embodiment of the invention, selected ones of the music renderers 126A-126M display the lyrics on an output device when the music renderer plays the selected music item.

The credits interface 356 allows the music renderer controller 148 to read credits that are associated with a selected music item, or to alternatively, to associate credits with a selected music item. In one embodiment, selected ones of the music renderers 126A-126M display the credits on an output device when the music renderer plays the selected music item.

The artwork interface 360 allows the music renderer controller 148 to read artwork that is associated with a selected music item, or to alternatively, to associate and store artwork with a selected music item. In one embodiment, the music renderer displays the artwork on an output device when the music renderer plays the music item.

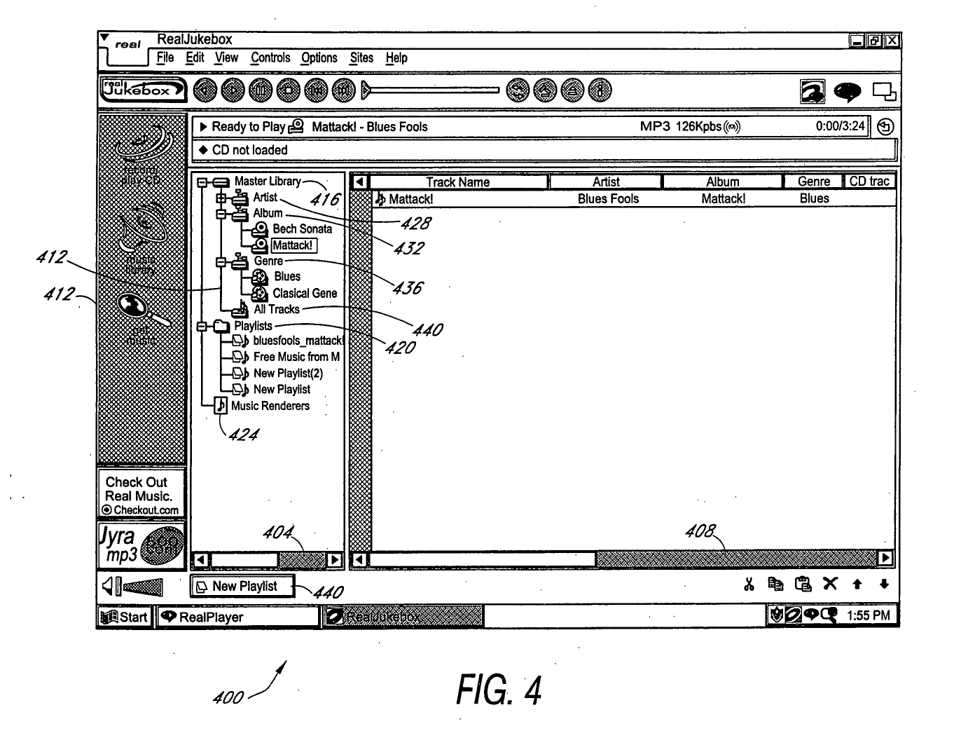

FIG. 4 is an exemplary screen display 400 that is presented to a user by the music player 144 (FIG. 1) via an output device of the client computer 104. Using the screen display 400, a user may: (i) play music that resides either on the client computer 104 or one of the music renderers 126A-126N; (ii) copy or move music items from the client computer 104 to one of the music renderers 126A-126N; (iii) copy or move music items from one of the music renderers 126A-126N to the client computer 104; (iv) copy or move music items from one music renderer to another music renderer; (v) install new music renderers; (vi) organize music into playlists; and (vii) download music from the music server 128 (FIG. 1).

The screen display 400 includes a library window 404 and an information window 408. The library window 404 includes a hierarchical graphical library tree 412 that organizes and classifies the music on the client computer 104 and the music renderers 126A-126N. The hierarchical graphical library tree 412 is comprised of a plurality of graphical nodes, each of the nodes (except root nodes) having one parent node and zero or more children nodes. Each of the nodes has an associated icon and/or text that is displayed to the user. The icon and/or text of a node identifies a classification that is associated with each of the children of the node. For example, as is described in further detail below, a node can be used to group music items according to author, album, or subject matter.

In one embodiment of the invention, the hierarchical graphical library tree 412 includes three root nodes, namely, a master library node 416, a playlist node 420, and a music renderer node 424. Furthermore, in one embodiment, the master library node 416 has four children, namely, an artist node 428, an album node 432, a genre node 436, and an all tracks node 440. The children of the artist node 428 are nodes that identify the names of various authors. For example, as is shown in FIG. 4, the user has music tracks from two different authors: Anastasia Khitul and the Blues Fools. By selecting one of the children nodes of the artist node 428, the user is presented via the information window 408 a list of all of the tracks that are associated with the selected artist.

The children of the album node 432 are nodes that identify the names of each of the albums that are maintained by the music player 144. As defined herein, an album is association of music or sound tracks. By selecting one of the children nodes of the album node 428, the user is presented via the information window 408 a list of all of the tracks that are associated with the selected album.

The children of the genre node 436 identify the names of one or more genres of music. For example, the children of the genre node 436 can include: blues, classical, rock and roll, country, hip hop, etc. Upon selecting one of the children nodes of the genre node 428, the user is presented in the information window 408 a list of all of the tracks that are associated with the selected genre.

Upon selecting the all tracks node 440 of the genre node 428, the user is presented in the information window 408 a list of all of the tracks that are maintained by the music player 144.

The playlist node 420 has as its children each of the playlists that have been created by the user of the client computer 104. As defined herein, a playlist is defined as a logical grouping of songs. Upon selecting one of the children nodes of the playlist node 420, the user is presented in the information window 408 a list of all of the tracks that are associated with playlist. The user can select a particular playlist and request the music player 144 to render each of the tracks that are associated with the playlist.

Upon selecting a new playlist button 440, the music player 144 enters a playlist mode wherein the user is allowed to prepare a new playlist, the new playlist associating together selected tracks that are maintained by the music player 144.

The music renderer node 424 has as its children a group of nodes that are each respectively labeled with the names of the music renderers 126A-126N. Upon selecting one of the children nodes of the music renderer node 424, the user is presented in the information window 408 a list of all of the tracks that are maintained by the selected music renderer.

Using one of the input devices of the client computer 104, the user can copy or move one of the nodes and all of the descendants of that node from a first part of the hierarchical graphical library tree to another. For example, the user can move all of the tracks that are associated with a blues genre node to a portable device. Furthermore, for example, the user can copy a playlist from the client computer 104 to one of the music renderers 126A-126N by selecting the playlist and “dragging” the playlist via one of the input devices of the client computer 104 to one of children of the music renderer node 424. As is appreciated by one of ordinary skill in the art, the term dragging refers to manipulating a graphical object on a display from a first location to a second location.

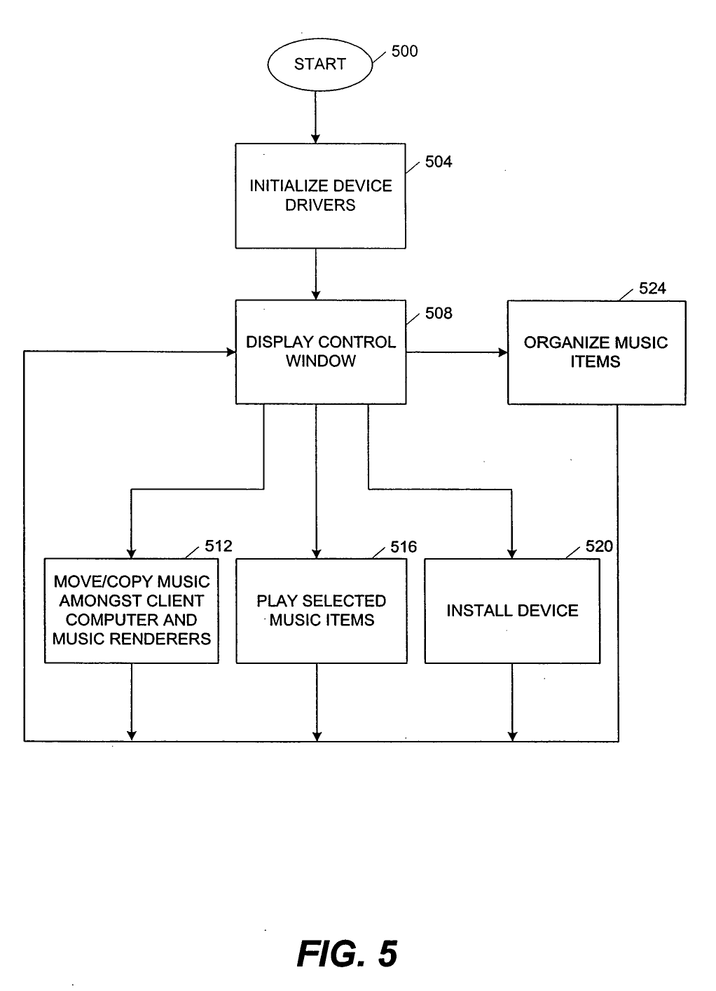

FIG. 5 is a high level flowchart illustrating a process for managing music items on the music renderers 126A-126N. Before starting at a start step 500, the user has executed the music player 144. The music player 144 communicates with the music renderer controller 148 to request that all of the music renderers be initialized. After starting at a step 500, the music renderer controller 148 proceeds to a step 504. At the step 504, the music renderer controller 148 initializes any pre-registered device drivers. During the initializing process, the music renderer controller 148 invokes the initialize adapter interface 304 and the initialize music renderer interface 308 that is associated with each device drivers 152A-152M that have been registered with the music renderer controller 148. Invoking initialize adapter interface 304 causes the device driver to initialize itself, and invoking the initialize music renderer interface 308 causes the device driver to initialize one of the music renderers 126A-126N to receive communications from the device driver.

Next, at a step 508, the music player 144 displays to a user a control window, such as is shown in FIG. 4. The control window allows the user to perform various acts with respect to the music items that are stored on the client computer 104 and on the music renderers 126A-126N. From the step 508, the music player 144 can, depending on the user's preference, proceed to either the steps 512, 516, 520, or 524. At the step 512, the user can move or copy music tracks amongst the client computer 104 and the music renderers 126A-126N. For example, the user can: (i) move or copy one or more selected music items from the client computer 104 to one of the music renderers 126A-126N; (ii) move or copy one more selected music items from one music renderer to another music renderer; or (iii) more or copy music items from one of the music renderers 126A-126N to the client computer.

Upon copying the music items to a selected music renderer, the music items are automatically transcoded and transcrypted depending on the requirements of the selected music renderer. For example, assume the user desires to copy one or more music items from the client computer 104 to the music renderer 126B. Furthermore, assume the client computer 104 maintains the music items as MP3 format and the music renderer 126B stores music items according to a proprietary format. The user indicates his desire for copying the selected music items by dragging the selected music items to the respective node of the music renderer in the hierarchical classification tree 412 (FIG. 4). The music player 144 invokes the need-to-convert interface 350 (FIG. 3) to determine whether the selected music item should be converted, e.g., transcoded or transcrypted, prior to transmitting the music item to the device driver. If the music item should be converted, the device driver reformats the music items to the appropriate format and transmits the formatted music item to the respective device driver for the selected music renderer 126B. It is noted that if the music items was a group of music tracks, i.e., a folder, the music player 144 formats each of the music tracks within the group before transmitting the tracks to the device driver. The device driver then stores the tracks according to any preferences that have been specified by the user, e.g., with or without lyrics, with graphical icons, etc. The process flow then returns to the step 508, whereby the user can select another option, or alternatively, stop the music player 144.

Referring again to the step 508, if the user requests to play one of the music items, the process flow proceeds to a step 516. At the step 516, the music player 144 plays via an output device of the client computer 104 one or more music items that have been selected by the user. The process flow then returns to the step 508, whereby the user can select another option, or alternatively, stop the music player 144.

Referring again to the step 508, if the user requests to install a new device, the process flow proceeds to a step 520. At the step 520, the user can request to install a new music renderer. In one embodiment of the invention, upon the request to install a new music renderer, the user is provided a list of music renderers that are supported by the music player 144. In this embodiment, the music player 144 may automatically or, alternatively, upon a user request, retrieve a list of music renderers that are supported by the music player 144. Upon the selection of a music renderer, the music player 144 identifies the location of a device driver for the selected music renderer. The location of the device driver for the selected music renderer can either be provided by the user or alternatively be maintained by the music server 128.

In one embodiment, if the device driver is not on the client computer 104, the client computer 104 requests another computer that is connected to the network 120 to transmits the device driver to the client computer 104. In another embodiment, the music player 144 requests the user to insert program storage device, such as a compact diskette, so that the music player 144 may copy the device driver to the client computer 104.

Once the device driver is in the client computer 104, the device driver is dynamically linked to the music renderer controller 148. The music renderer controller 148 executes the initialize adapter interface 304 and the initialize music renderer interface 308 of the device driver. Furthermore, the music player 144 registers the device driver in an internal registry so that the music player 144 will initialize the device driver upon future invocations of the music player 144. The process flow then returns to the step 508, whereby the user can select another option, or alternatively, stop the music player 144.

At the step 524, the music player 144 enters a playlist mode that allows the user to organize the music items on the client computer 104 and the music renderers 208A-208N. The user can group selected music items into a playlist. The process flow then returns to the step 508, whereby the user can select another option, or alternatively, stop the music player 144.

Advantageously, by providing a music renderer controller 148 that is designed to communicate with device drivers by a predefined interface, i.e., the DIAPI, one or more new device drivers can be added at later date and can communicate with the music player 144. The interface to the music player 144 is independent on the particular characteristics of each of the music renderers 126A-126N.

The DIAPI of the music renderer controller 148 gives the music renderer manufacturers flexibility to define what actions can be performed with respect to the music renderer. For example for copyright and other statutory concerns, some manufacturers of music renders may desire that users not be able to read from the music renderer. Assuming the music renderer supports such functionality, a user could be prevented from writing to the music renderer by programming the adapter to refuse all read requests with respect to the tracks on the music renderer.

Furthermore, by using the DIAPI, changes in firmware of one of the music renderers 126A-126N do not necessitate changes in the electronic music player 144. If the firmware of one the music renderers 126A-126N is modified, a new device driver may be created to communicate with the music renderer controller 148.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

1. A music rendering system for transferring a music item between a computer device and a music renderer, comprising:
a music controller program code operative to be executed on the computer device for managing at least one music item, the music controller program code operative when executed to retrieve attribute information from a music renderer when the music renderer is coupled with the computer device, wherein the attribute information provides an indication of attributes of the music renderer during the operation of the music controller program code, the music controller program code operative to change the data format or compression of the music item as a function of the retrieved attribute information; and
the music controller program code operative to transmit the changed music item to a music renderer.

2. The system of claim 1, wherein the music item is a track of music.

3. The system of claim 1, wherein the music items are a set of tracks.

4. The system of claim 1, additionally comprising an electronic music player for managing the music items, the electronic music player displaying a hierarchical graphical library tree that graphically classifies the music items into one or more sets, the electronic music player transmitting a selected set of music items to the music renderer upon a request from a user.

5. The system of claim 4, wherein the music item is received from a remote server via a network.

6. The system of claim 1, the music controller program code operative to request a device driver to provide a description of storage objects that are supported by the device driver.

7. The system of claim 1, the music controller program code operative to request a device driver to provide storage capacity of storage devices that are associated with the device driver.

8. The system of claim 1, the music controller program code operative to request a device driver to reorder one or more music items that reside on the music renderer.

9. The system of claim 1, the music controller program code operative to request a device driver to provide the number of tracks that are on the music renderer.

10. The system of claim 1, the music controller program code operative to store artwork with respect to a selected track on the music renderer.

11. The system of claim 1, the music controller program code operative to store credits with respect to a selected track on the music renderer.

12. The system of claim 1, the music controller program code operative to store lyrics with respect to a selected track on the music renderer.

13. The system of claim 1, the music controller program code operative to define a selected bit-rate with respect the music renderer, and to convert any received music items to the selected bit-rate before transmitting the music items to the music renderer via a device driver.

14. The system of claim 1 the music controller program code operative to convert the music item from a first bit rate to a second bit rate.

15. A method of transferring music items between a music renderer and an electronic music player comprising an output device, the method comprising:
storing a music item in a memory of the electronic music player in a first predetermined format;
coupling the music renderer with the electronic music player;
retrieving attribute information about the music renderer;
displaying on the output device, as a result of the retrieved attribute information, data referencing the music renderer;
providing an indication to reformat the music item into a second predetermined format in accordance with the retrieved attribute information;
reformatting the music item into a second predetermined format; and
transferring the reformatted music item to the music renderer.

16. The method of claim 15, further comprising reformatting the music item into a second predetermined format by changing the encoding of the music item, changing the rights associated with the music item, or changing the data format of the music item.

17. The method of claim 15, wherein said attribute information about the music renderer is retrieved from the coupled music renderer.

18. The method of claim 15 further comprising receiving the music item in the first predetermined format from a remotely located server via a network.
